(19) United States
(12) Patent Application Publication
(10) Pub. No.: US 2009/0178757 A1
(43) Pub. Date: Jul. 16, 2009

(54) Method for regulating the strain of a tire reinforcement

(76) Inventors: Jose Cocovi, Volvic (FR); Jean-Claude Delorme, Mirefleurs (FR)

Correspondence Address: COHEN, PONTANI, LIEBERMAN & PAVANE LLP, 551 FIFTH AVENUE, SUITE 1210, NEW YORK, NY, 10176, US

(21) Appl. No.: 11/988,493

(22) PCT Filed: Jul. 7, 2006
(86) PCT No.: PCT/EP2006/064006

§ 371 Date: Feb. 11, 2009

(30) Foreign Application Priority Data
Jul. 8, 2005 (FR) 0507414

(51) Int. Cl. B29D 30/16

(52) U.S. Cl. 156/117; 156/397

(57) ABSTRACT

A fabrication method for a tire comprising a circumferential reinforcement, the said method comprising a stage during which a thread is wound around a form, the tension of the thread being managed during winding, in which method the thread tension is managed through the length of a compensation loop acted upon by a spring.

The present invention concerns the fabrication of tires. More precisely, it relates to the laying, as the tires are being built, of reinforcements designed to constitute a circumferential reinforcement of the tire. In particular the present invention proposes means and a method for controlling the tension under which such a reinforcement is wound onto the tire blank.

In the field of tires, reinforcement is understood to mean the presence within the elastomeric material of reinforcement elements (also simply called “reinforcements”). These reinforcements are generally of considerable length and impart to the final product a rigidity and strength quite different from those of the matrix of elastomeric material.

Such reinforcements are often individually in the form of a thread of great length. In the remainder of this application the term “thread” should therefore be understood in its entirely general sense, which encompasses a monofilament, a multifilament, an assembly such as a cable or folded yarn, or a small number of cables or folded yarns grouped together, and this whatever the nature of the material, for example textile or metallic.

Circumferential reinforcements are mainly used in two distinct parts of the tire. They are used for example to make the bead wires of the tire (see patent application EP 0 582 196) or to make a circumferential reinforcement of the tire's crown. “Zero degree reinforcements” are also mentioned. In reality the orientation of the reinforcement is close to 0° but is seldom precisely equal to 0°. In effect, as several turns are wound on at a given pitch, it can happen that the reinforcement makes an angle of up to a few degrees relative to the median plane of the tire.

The thread can be coated with rubber before being wound on (and is then said to be “rubberized”). The thread can also be wound on while “bare”, i.e. not rubberized. The bare thread is then positioned between layers of rubber. Those layers of rubber either come from other constituents of the tire, or are provided specifically.

The winding on of the circumferential reinforcement can be done during a building process on a flexible or rigid core. It can also be done during a process that comprises a stage of building a first tire blank on a cylindrical drum, followed by a stage in which the crown elements are positioned once the first blank has been inflated. In the case of a circumferential crown reinforcement, the reinforcement can also be wound on within an annular crown block at the centre of which a carcass is then positioned and inflated in order to join the two sub-assemblies before vulcanization.

Regardless of the building method, the part of the tire receiving the circumferential reinforcement and the type of thread used, it is desirable to apply a certain tension to the thread while it is being wound on. During a given winding-on operation that tension may be constant or, on the contrary, variable. In the present application the terms “manage” and “management” are usually employed to denote the action or act of regulating, that is to say of actively keeping a parameter at a given level, whether this level be fixed or variable.

However, there is a difficulty with reliably and precisely managing this winding tension. In this context the document EP 0 344 928 proposes to modulate the tension with the aid of a friction roller connected to a direct-current electro-mechanical machine. Control of the current consumed or delivered by the electro-mechanical machine enables the thread tension to be varied. The document EP 1 022 119 proposes a method and device in which the tension is produced and deduced indirectly from the difference of rotation speeds between the drum on which the thread is wound and the pulley delivering the thread. In effect a particular speed difference corresponds to a particular thread elongation, and a given thread elongation corresponds to a given tension. The document US 2003/0106628 proposes to position the driving pulley as near as possible to the drum and to control the position of the pulley continuously as a function, in particular of the effective tension of the thread.

A problem shared by these various systems is that the inertia of the elements and/or small, instantaneous variations of the radius of the turns and/or perturbations caused by the regulation system give rise to large variations of the actual winding tension, because of the rigidity of the reinforcement.

An objective of the present invention is therefore in particular to propose a method and device in which undesirable variations in the effective winding tension are reduced.

For this, the invention proposes a fabrication method for a tire comprising a circumferential reinforcement, the said method comprising a stage in which a thread is wound around a form, the tension of the thread being managed during the winding, in which method this winding tension is managed through the length of a compensation loop acted upon by a spring.

Preferably, the thread tension is managed by means of a motorized pulley which delivers the thread upstream of the compensation loop, the motorized pulley being controlled as a function of variations in the length of the compensation loop.

Preferably, the compensation loop length variations are deduced from the position of a mobile pulley acted upon by the spring.

Preferably, the motorized pulley is also controlled as a function of a measurement of the effective speed of the thread downstream of the compensation loop.

Preferably, the effective tension of the thread downstream of the compensation loop is also measured.

Preferably, the form is a rigid core on which the tire is built, the outer configuration of the core corresponding essentially to that of the internal cavity of the tire in the finished condition.

Preferably, the circumferential reinforcement is a circumferential crown reinforcement. It is also preferable for the thread tension to vary along a given profile over the width of the said crown.

Preferably, two threads are wound simultaneously onto the same form. It is also preferable for the two threads to be adjacent within the winding.

The invention also concerns a thread feed device for winding a circumferential tire reinforcement around a form, the tension of the thread being managed, the said device comprising:
a motorized pulley,
a compensation loop acted upon by a spring, the said loop being located downstream of the motorized pulley,
a sensor sensitive to variations in the length of the compensation loop,
means for controlling the motorized pulley, capable of controlling the rotation of the motorized pulley as a function of the length variations of the compensation loop.

Preferably, the thread feed device also comprises a sensor sensitive to the effective tension in the thread, this effective-tension sensor being located downstream of the compensation loop.

Preferably, the device also comprises a sensor sensitive to the effective speed of the thread, this effective-speed sensor being located downstream of the compensation loop.

The invention also concerns a machine for building tires, comprising two devices as described above arranged within the machine so as to enable the simultaneous winding of two threads around a single form. It is also preferable for the building machine also to comprise a robot capable of guiding the adjacent winding on of the two threads.

The remainder of this description enables all the aspects and advantages of the invention to be understood clearly, with reference to the following figures:

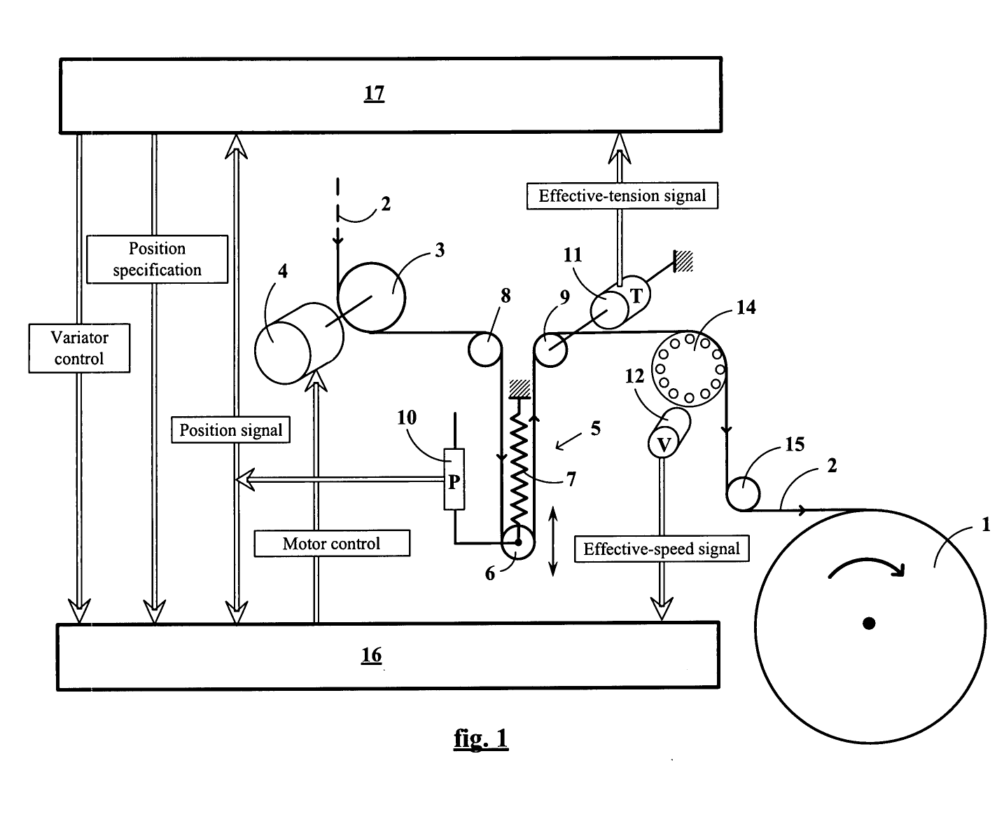

FIG. 1 is a schematic representation illustrating both the method and an embodiment of the device according to the invention.

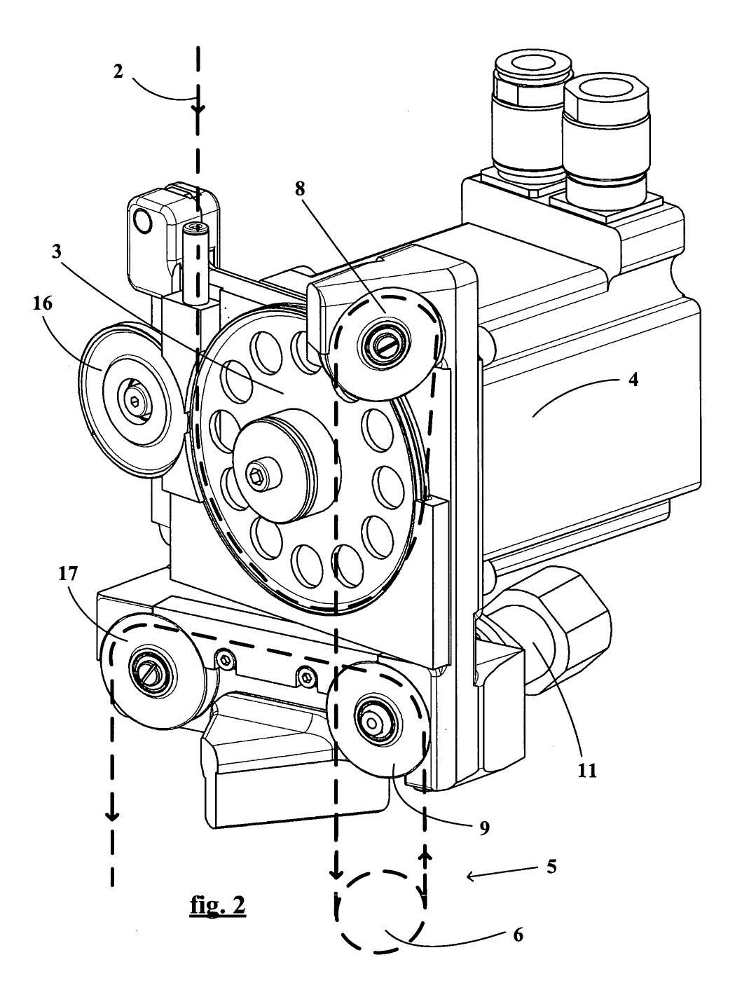

FIG. 2 is a perspective view of a first part of a preferred embodiment of the device according to the invention.

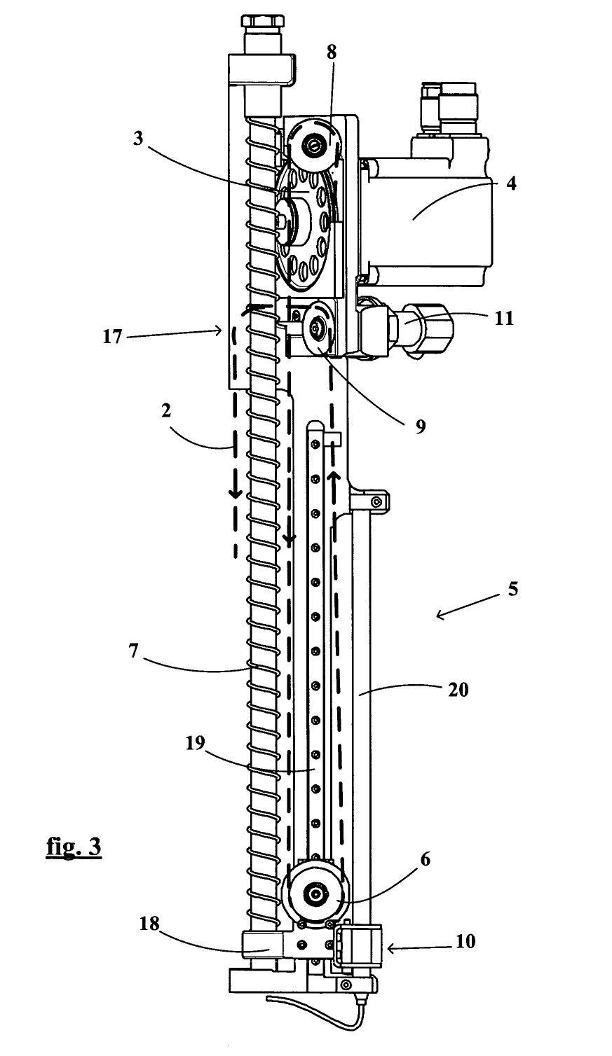

FIG. 3 is essentially a front view of a second part of the preferred embodiment of the device in FIG. 2, in which the first part can also be seen.

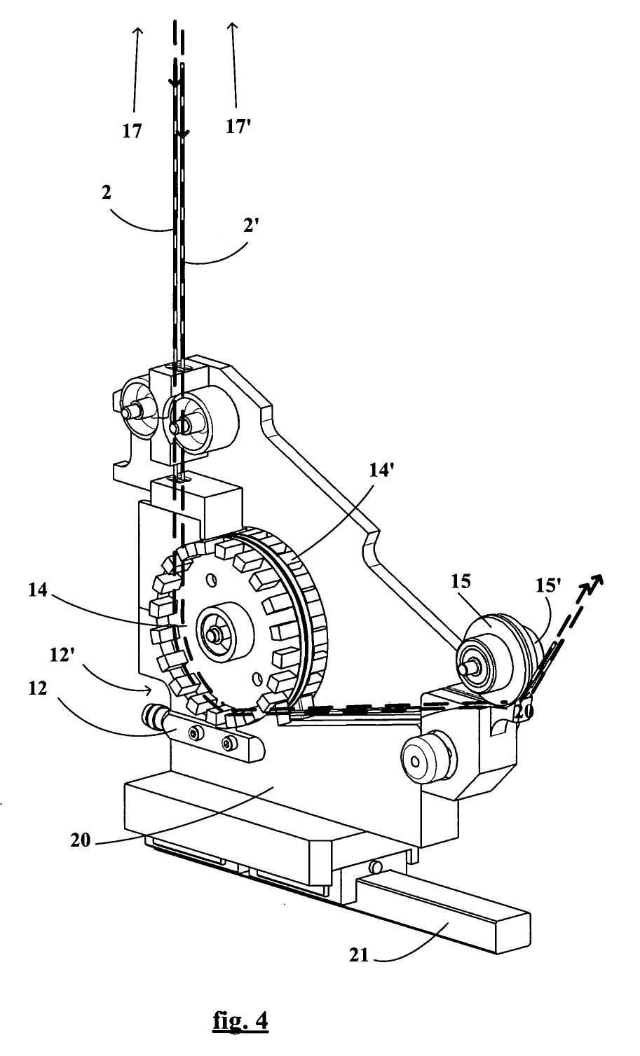

FIG. 4 is a perspective view of a third part of the preferred embodiment of the device in FIG. 2

FIG. 5 is essentially a front view of the whole of the preferred embodiment of the device in FIG. 2

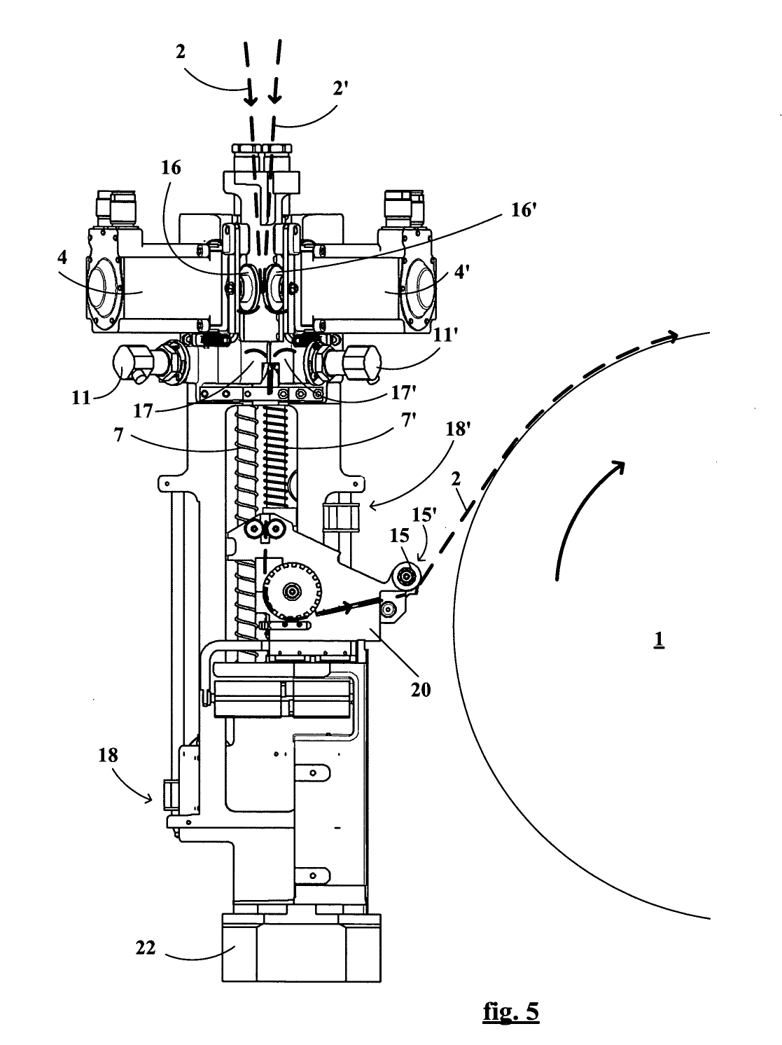

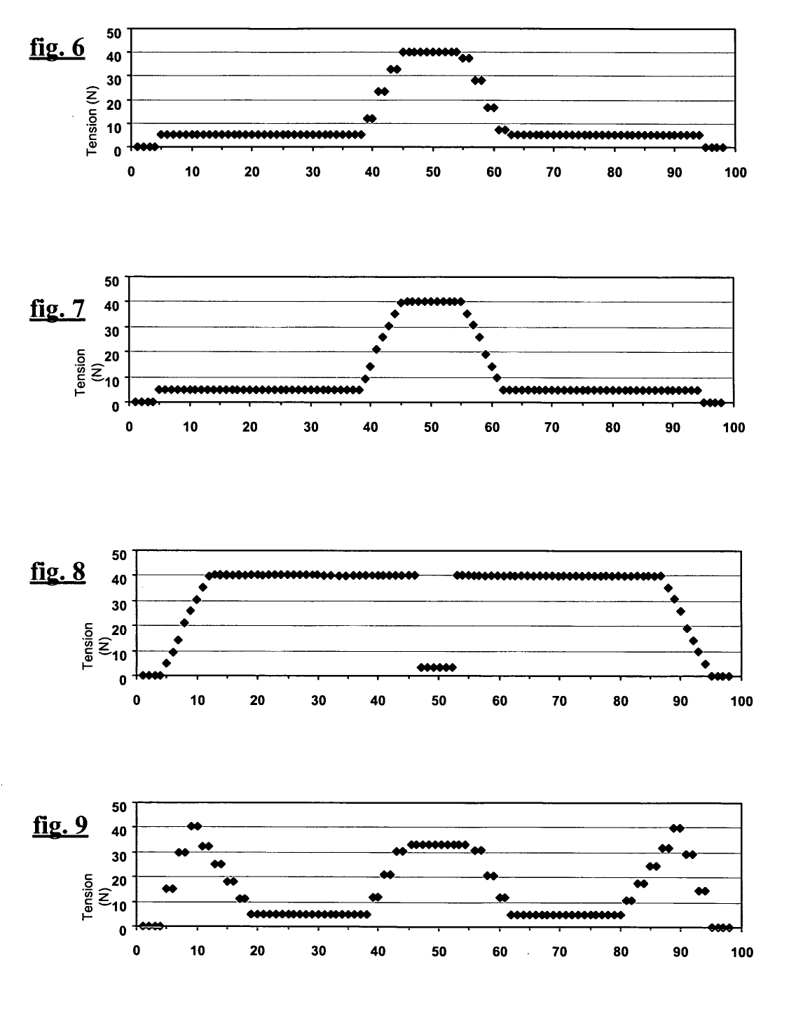

FIGS. 6 to 9 are graphs showing examples of tension variations within a circumferential crown reinforcement.

In the various figures, identical or similar elements are indexed with the same numbers. Accordingly, their description is not repeated systematically.

FIG. 1 shows a schematic representation of a preferred embodiment of the managed-tension thread feed device according to the invention. This representation also illustrates the fabrication method according to the invention.

A form 1 is driven in rotation so as to wind on a certain number of turns of the thread 2. As described earlier, the form 1 can be for example a tire blank prepared on a flexible or rigid core, a tire blank prepared on an inflated membrane, or a crown block blank prepared on a temporary support before then being assembled on the carcass of the tire.

The thread 2 is pulled through the device as a whole by the rotation of the form 1. Within the device, the path followed by the thread is as follows: The thread 2, coming for example from a storage spool (known per se and not represented here) passes around a motorized pulley 3 designed to control the speed of the thread. The thread must not be able to slip on the pulley (at any rate it must not be able to slip so much that controlling its speed becomes impossible). The motorized pulley 3 is connected to an electro-mechanical machine 4. The electro-mechanical machine can act as a motor or as a brake. In the remainder of this description, in line with current practice, such an electro-mechanical machine will simply be called a “motor”. The motor 4 is for example a synchronous motor of the “brushless” type. Downstream of the motorized pulley the thread then passes into a compensation loop 5. In a way known per se, by creating a buffer supply, a compensation loop makes it possible to absorb variations in the thread length or thread speed thereby limiting the disruption this causes to the method, particularly by limiting variations in tension. As a preference, the two strands of the compensation loop are parallel over a long compensation range.

The loop 5 comprises a mobile pulley 6 acted upon by a spring 7. The pulleys 8 and 9 are carried by essentially fixed axles. It will be understood that for a given vertical position of the mobile pulley 6, the spring exerts a given force on the pulley. This force corresponds to the sum of the tensions of the descending and ascending strands of the loop; i.e. to twice the tension in the thread. Thus, the tension value is related to the position (in this case vertical) of the pulley. The more the spring is compressed, the higher the tension. The pulleys 6, 8 and 9 are free-running, i.e. they rotate freely under the effect of the movement of the thread 2. It is understood that during winding, (the rate of which is dictated by the speed at which the form 1 rotates), depending on the rotation speed imparted to the drive pulley 3, the length of the loop 5 can be increased so as to reduce the tension or, on the contrary, the length of the loop 5 can be reduced so as to increase the tension of the thread.

Preferably, the position of the mobile pulley is tracked by a position sensor 10. The signal emitted by this sensor is therefore representative of the tension of the thread in the compensation loop 5. The motorized pulley 3 is then controlled as a function of the signal emitted by the position sensor 10. Alternatively, a direct sensor of the force exerted by the spring 7 can be used because the signal from such a sensor is a good representation of the length variations of the compensation loop.

Advantageously, downstream of the compensation loop the device also comprises an effective speed sensor 12. In this example the speed sensor functions as follows: the thread drives a free-running pulley 14 without slipping. The position of that pulley is detected in real time by the sensor 12, which can for example be an optical or magnetic sensor. The speed-representative signal emitted by the sensor 12 can be used to refine the control of the motor 4. In effect, to improve the precision and responsiveness of regulation, it may be expedient to use a reference speed in relation to which the speed of the motorized pulley 3 is regulated as a function of the length of the compensation loop. Measuring the speed of the winding also makes it possible to anticipate movements of the compensation loop and thus further reduce the variations in tension. This effective-speed measurement can also enable redundancy with the data relating to the speed of the thread that can for example be deduced from signals emitted by the motor 4, the motorized pulley 3 or the rotation of the form 1.

Advantageously, downstream of the compensation loop the device also comprises an effective-tension sensor 11. In this example the effective-tension sensor functions as follows: the thread passes over a free-running pulley 9. The axle or axle support of that pulley is equipped with strain gauges which deliver a signal that represents the radial force experienced by the pulley and thus also represents the effective tension. The signal emitted by the tension sensor can be used to check and/or record the value of the tension and its evolution for each tire over time. This measurement is independent of the regulation described above. If necessary, the signal can be used to trigger an alarm if a deviation is detected. This measurement can also be used for calibrating the device, i.e. for establishing the relationship between the signal representing the position of the mobile pulley 6 and the thread tension effectively delivered by the device. This measurement of effective tension can also (during normal operation of the device) enable a redundancy with the data relating to thread tension deduced from the signals relating to the position of the mobile pulley 6.

In this example the tension pulley 9 also serves as a deflector element in the compensation loop 5, but an independent implantation is entirely possible.

Similarly, in the example shown here the speed pulley 14 is independent of the deflector and tension pulley 9. On the other hand, these three functions could be combined in a single pulley.

Here, the regulation and control system is represented in the form of two distinct elements 16 and 17. This representation brings out more clearly the various functions of the system, but it is understood that in practice the whole can be integrated in a single module or, on the other hand, in more than two distinct modules.

The function of the variator 16 is to control the rotation of the motor 4. To do this, it receives the position signal from the mobile pulley position sensor and compares it with a position specification. Preferably, the variator 16 also receives an effective-speed signal from the speed sensor 12 and integrates it in the determination of the control command it transmits to the motor.

The function of the controller 17 is to initiate and guide the operation of the thread feed device and in particular to provide the variator 16 with the position specification during the circumferential reinforcement laying programme. A further function of the controller 17 can be to receive, record and process the effective-tension signal emitted by the sensor 11 and, if necessary, to compare that signal with the signal from the position sensor 10 and/or with the position specification representing the tension desired. A supplementary function of the controller can be to store the various prescriptions that enable each different type of tire to be produced. Of course, the controller can also have any other function of interfacing with the operator and/or with the industrial environment of the device, for example with the machine in which the device can be integrated.

Preferably, the tension is regulated by controlling the speed of the motorized pulley. However, the tension can also be regulated by controlling the torque applied to the motorized pulley.

FIG. 2 shows a first part of a preferred embodiment of the device according to the invention. This part mainly concerns the elements located on either side of the compensation loop. In the figure can be seen the motorized pulley 3, its motor 4, the deflector pulleys 8 and 9 and the effective-tension sensor 11. Let us follow the path of the thread 2, represented here by a broken line. The thread 2 passes vertically into the device. A pressure roller 16 limits the risk that the thread will slip on the motorized pulley 3. The thread makes approximately a half-turn of the pulley 3. It is then deflected by the deflector pulley 8 towards the vertical compensation loop 5 (the mobile pulley 6 is represented schematically here by a broken line). On leaving the loop 5, the thread passes over the deflector pulley 9 whose axle is carried by the effective-tension sensor 11. A final deflector pulley 17 directs the thread vertically towards the laying unit that can be seen in FIGS. 4 and 5.

Besides the sub-assembly described in FIG. 2, FIG. 3 shows in detail the constitution and implantation of the compensation loop in this preferred embodiment of the device according to the invention. As can be seen, the loop 5 extends vertically below the sub-assembly described in FIG. 2. The mobile pulley 6 is mounted on a carriage 18 guided on a rail 19. The position sensor 10 that senses the position of the mobile pulley emits a signal representing the position of the carriage relative to a fixed slideway 20. The carriage 18 is subjected to the compression force of the spring 7 which tends to make the loop 5 longer. It will be readily understood that the force exerted by the spring varies as a function of the position of the carriage, i.e. as a function of the length of the compensation loop. The spring is preferably relatively long and flexible so as simultaneously to allow a great deal of compensation and a very small variation in tension over small amplitudes and therefore good precision with which the tension can be controlled through the position of the mobile pulley. A spring stiffness of the order of 0.5 N/mm provides satisfactory results.

One principle of the invention is clearly illustrated here, namely the fact that the compensation loop has a dual role: on the one hand, it creates, maintains and modulates the tension, this first role being performed through the variable force of the spring, and, on the other hand it provides data for managing the tension, this second role being performed through the length of the loop.

FIG. 4 shows a preferred embodiment of the thread laying means located downstream of the compensation loop. In this preferred embodiment two threads 2 and 2′ move in parallel. Each thread comes from a different compensation loop. The two threads 2 and 2′ therefore come from two distinct assemblies such as the assembly shown in FIG. 3. Each thread drives a different speed pulley, 14 and 14′ respectively. Respective speed sensors 12 and 12′ emit signals representing the speed of the respective threads 2 and 2′. The threads are then guided by respective laying rollers 15 and 15′ towards the form around which they are being wound. The laying unit 20 shown in this FIG. 4 can be mobile relative to a rail 21, for example in order to enable rapid approach and withdrawal movements relative to the form 1. By virtue of the vertical and relatively high feeding of the laying unit, these horizontal movements of limited amplitude have no appreciable effect on the tension regulation.

It is understood that all the functions of this sub-assembly are duplicated in relation to the explanation of FIG. 1. Half of the sub-assembly suffices for the winding of a single thread in accordance with the invention.

FIG. 5 shows a preferred embodiment of the invention in which two feed devices are associated in order to enable the simultaneous winding of two threads. Two sub-assemblies such as the one in FIG. 2 feed two parallel compensation loops. As in FIG. 4, the indexes relating to the feeding of the second thread 2′ are identical to those relating to the feeding of the first thread 2 but are distinguished therefrom by the addition of a prime “′” symbol. The elements shown in front view in FIG. 3 are viewed from the rear in FIG. 5. To illustrate the independence of the tension regulation of each of the two threads, the spring 7 on the left has been shown less compressed than the spring 7′ on the right. Thus, the carriage 18 on the left is in its lowest position while the carriage 18′ on the right is in its highest position. A laying unit 20 for two threads such as the one in FIG. 4 receives the two threads coming from the deflector pulleys 17 and 17′ and guides them as they are wound around the form 1. Preferably, a shoe 22 attached to the two associated devices enables proper holding by a robot (not shown).

The tire-building machine according to the invention comprises a thread feeding device such as that described above, and preferably two devices are associated in parallel as in FIG. 5. In the context of automated tire building, the positioning of the device(s) relative to the rotating form can be carried out by a robot. The robot will then move the two feed devices as one relative to the form in order to effect the desired helicoidal winding. During simultaneous winding with two devices, the tension of each thread is regulated independently. The specified tension may therefore be equal for each of the two threads, or it may be different. Preferably, the two threads are laid one next to the other, i.e. they remain adjacent at all times, including within the finished tire. If it is desired to vary the winding pitch, it can be advantageous also to allow variation of the distance between the two laying rollers (see the elements indexed 15 and 15′ in FIG. 4) in order to distribute the windings on the form.

FIGS. 6 and 7 show examples of tension profiles that can be obtained by means of the method using the machine according to the invention. For each turn of the winding, the graphs show the value of the thread tension specification. The turns are numbered in sequence (along the abscissa axis of the graphs) and the tension specification is expressed here in Newtons (N) (plotted on the ordinate axis of the graphs).

The cases illustrated here relate to the laying of a circumferential crown reinforcement by winding two bare threads side by side. The winding (and thus the counting of turns) begins here at the left-hand shoulder of the tire. Thus, the graphs indicate the desired evolution in the tension across the width of the circumferential reinforcement.

The laying begins (here, the first two turns of each thread, therefore four turns) under almost no tension in order to avoid any slipping of the threads on the form, and the tension is then set to about 5 Newtons. In the central portion of the circumferential crown reinforcement the threads in this case have a tension of around 40 Newtons. The transition between these two tension levels preferably takes place progressively. In the example of FIG. 6 it can be seen that the tension specifications increase progressively towards the central portion and decrease in the same way beyond the central portion. However, in the example of FIG. 6 the specifications remain identical, in pairs, i.e. at any given time each of the two threads being wound on simultaneously is under the same tension. In the example of FIG. 7, in contrast, it can be seen that the tension specifications for each of the two threads are different in the transition zones. This allows an even more gradual evolution of the tension instead of an evolution in a succession of steps for both threads. As mentioned earlier, the invention enables the tension of each thread to be managed individually at any time, so the tension profile of the two threads can be different or identical.

Other tension profile examples are shown in FIGS. 8 and 9. The one in FIG. 8 shows a rapid tension increase at the shoulder of the tire towards the maximum tension. This increase is distributed over eight windings, i.e. four turns of two threads. In the central portion of the tread the tension is greatly reduced for three turns. Note that in this example the tension specification is sometimes different between a pair of adjacent threads in order to smooth the profile in the variation zones, as in FIG. 7. The tension profile in FIG. 9 shows a rapid tension increase at the shoulder of the tire towards the maximum tension, at which just one turn is made, then an equally rapid decrease to an intermediate zone in which the tension is very low. In the central zone of the tread the tension is again high. Note that in this example the tension specification is always identical between a pair of adjacent threads

The profiles represented here are essentially symmetrical but that is not always desirable or necessary. For example, the tension can be chosen as a function of the mass distribution of the tread pattern intended to cover the circumferential crown reinforcement, and that distribution is not always symmetrical. Similarly, the stresses imposed on the tire during its use may motivate designers to choose different tensions between the outside and inside portions of the tread.

When the building machine uses two thread feed devices in parallel, it is understood that the two devices can share certain elements such as for example pulley supports, the variator or the controller.

Advantageously, the method according to the invention uses the principle of building on a rigid core. When the core used is of the type said to be “rigid”, i.e. its volume does not vary (at any rate not beyond the effect of thermal variations) between the building and the moulding of the tire, what is termed the “shaping supplement” cannot be used to place the circumferential reinforcement under tension at the time of moulding. One also speaks of a “non-shaping” fabrication method. Thanks to the invention, in this case a final tension can be applied which is chosen and variable for each zone of the tire without this being dependent upon the moulding operation.

By virtue of the invention it becomes possible, in the context of tire manufacture, to lay windings under controlled tension and at high speeds, for example at speeds well in excess of 10 metres per second and which can quickly be varied (over 6 m.s-2) with an effective-tension precision of better than 10%, something which is entirely unconceivable with the methods and devices of the prior art.

A “bare” thread is understood to mean one that is not “rubberized”. The thread is rubberized if it is coated with a sheath of rubber able to provide the quantity of rubber required for the reinforcement envisaged, i.e. no additional provision of rubber is needed. However, a bare thread can be coated by any treatment designed for example to protect it from oxidation or to promote subsequent bonding with the matrix of elastomeric material. Accordingly, the thread can still be called “bare” even if this treatment contains an elastomeric material.

The invention can be applied to tires of any type, for example for passenger cars, heavy vehicles, motorcycles, construction machinery, etc.

1. A fabrication method for a tire comprising a circumferential reinforcement, the said method comprising a stage in which a thread is wound around a form, the tension of the thread being managed during winding, in which method the tension is managed through the length of a compensation loop subjected to the action of a spring.

2. The method according to claim 1, in which the system for managing the tension of the thread uses a motorized pulley which delivers the thread upstream of the compensation loop, the motorized pulley being controlled as a function of the length variations of the compensation loop.

3. The method according to claim 2, in which the length variations of the compensation loop are deduced from the position of a mobile pulley subjected to the action of the spring.

4. The method according to claim 2, in which the motorized pulley is also controlled as a function of a measurement of the effective speed of the thread downstream of the compensation loop.

5. The method according to claim 1, in which the effective tension of the thread is also measured downstream of the compensation loop.

6. The method according to claim 1, in which the form is a rigid core on which the tire is built, the external configuration of the core corresponding essentially to that of the internal cavity of the tire in its finished state.

7. The method according to claim 1, in which the circumferential reinforcement is a circumferential crown reinforcement.

8. The method according to claim 7, in which the thread tension varies in accordance with a given profile across the width of the said crown.

9. The method according to claim 1, in which two threads are wound simultaneously onto the same form.

10. The method according to claim 9, in which the two threads are adjacent within the winding.

11. A thread feeding device for winding a circumferential tire reinforcement around a form, the tension of the thread being managed, wherein the device comprises:
a motorized pulley;
a compensation loop subjected to the action of a spring, the said loop being located downstream of the motorized pulley;
a sensor which is sensitive to variations in the length of the compensation loop; and
means for controlling the motorized pulley capable of controlling the rotation of the motorized pulley as a function of the length variations of the compensation loop.

12. The thread feeding device according to claim 11, also comprising a sensor sensitive to the effective tension of the thread, the effective-tension sensor being located downstream of the compensation loop.

13. The thread feeding device according to claim 11, also comprising a sensor sensitive to the effective speed of the thread, the effective-speed sensor being located downstream of the compensation loop.

14. A tire building machine comprising two devices according to claim 11, wherein the devices are arranged in the machine in such manner as to enable the simultaneous winding of two threads around a single form.

15. The tire building machine according to claim 14, also comprising a robot capable of guiding the adjacent winding of the two threads.
